(19) United States
(12) Patent Application Publication
(10) Pub. No.: US 2018/0313257 A1
(43) Pub. Date: Nov. 1, 2018

(54) AXIAL PISTON MOTOR AND METHOD FOR OPERATION OF AN AXIAL PISTON MOTOR

(71) Applicant: GETAS Gesellschaft fuer thermodynamische Antriebssysteme mbH, Dueren (DE)

(72) Inventors: Ulrich ROHS, Dueren (DE); Dieter VOIGT, Aachen (DE)

(73) Assignee: GETAS Gesellschaft fuer thermodynamische Antriebssysteme mbH, Dueren (DE)

(21) Appl. No.: 15/770,271

(22) PCT Filed: Oct. 13, 2016
(86) PCT No.: PCT/DE2016/100479

§ 371 Date: Apr. 23, 2018

(30) Foreign Application Priority Data
Oct. 26, 2015 (DE) 10 2015 118 239.4

(51) Int. Cl. F02B 33/06; F02B 75/26; F01B 3/00; F01B 3/04; F02B 29/04

(52) U.S. Cl. CPC F02B 33/06; F02B 75/26; F02B 29/04; F01B 3/0032; F01B 3/04; F01B 3/0005

(57) ABSTRACT

An axial piston motor with inner continuous combustion burns a compressed combustion medium with fuel in a continuously operating combustion chamber to form a working medium, the working medium is supplied to cyclical working cylinders in order to extract mechanical energy, and the mechanical energy extracted in the working cylinders is also used for the compression of the combustion medium. The compression is carried out in two steps or at a compression end temperature of less than 300° C. with a compression ratio of more than 10 and/or a rotating distributor includes at least two distributor openings which cyclically open and close the firing connections and/or are cyclically guided past or through firing channels.

The invention relates to an axial piston motor with internal continuous combustion, having a continuously operating combustion chamber, having at least two working cylinders, and having at least two compressor cylinders driven by the working cylinders, wherein firing connections between the continuously working combustion chamber and the working cylinders can be cyclically closed and opened, and wherein a combustion medium feed line for supplying compressed combustion medium to the continuously working combustion chamber is provided between the compressor cylinders and the combustion chamber. Likewise, the invention relates to a method for operation of an axial piston motor with internal continuous combustion, in which compressed combustion medium is combusted in a continuously working combustion chamber together with fuel, the working medium is cyclically supplied to working cylinders so as to obtain mechanical energy, and the mechanical energy obtained in the working cylinders is also used for a compressing combustion medium.

Motors of an entirely different nature have been disclosed in DE 691 12 142 T2, in U.S. Pat. No. 4,783,966 or U.S. Pat. No. 5,964,087, in which discontinuous combustion is present, wherein air or an air/fuel mixture is compressed, in each instance, the compressed air or the air/fuel mixture is then supplied to a combustion chamber or a working cylinder in surges, wherein in the case of compressed air, fuel is then also added to the compressed air, and subsequently, the compressed air/fuel mixture is ignited and supplied, in its entirety, to a working cylinder. The combustion procedure then ends and is only initialized again when compressed air is once again made available. This means that the entire combustion process is significantly determined by the beginning and the end of the respective combustion procedure. The compression/expansion ratio is also decisively determined by the ratios of the cylinder diameters or the stroke volumes during compression and expansion.

Motors with internal continuous combustion are already sufficiently known from U.S. Pat. No. 972,404, for example, as piston motors. Also, axial piston motors are described in U.S. Pat. No. 5,228,415 or in DE 31 35 619 A1, wherein internal continuous combustion as such is not disclosed for this motor type. EP 1 035 310 A2 and WO 2011/009454 A2 also disclose axial piston motors with internal continuous combustion, wherein the axial piston motors of the latter two documents have a continuously working combustion chamber, at least two working cylinders, and at least two compressor cylinders driven by the working cylinders, in each instance, wherein firing connections between the continuously working combustion chamber and the working cylinders can be cyclically closed and opened, and wherein a combustion medium feed line for supplying compressed combustion medium to the continuously working combustion chamber is provided between the compressor cylinders and the combustion chamber. Likewise, the latter two documents disclose a method for operation of an axial piston motor with internal continuous combustion in which compressed combustion medium is combusted, together with fuel, in a continuously working combustion chamber, to produce working medium, the working medium is cyclically supplied to working cylinders to obtain mechanical energy, and the mechanical energy obtained in the working cylinders is also used for compression of the combustion medium. Here, EP 1 035 310 A2 uses sleeves for cyclical opening and closing of the firing connections, which sleeves are disposed around the working cylinders, in each instance, and rotate around them, wherein openings in these sleeves are then used for opening and closing the firing connections. According to WO 2011/009454 A2, control pistons can also be used instead of these sleeves, which pistons cyclically open and close the firing connections accordingly. Furthermore, the latter document discloses that the working medium is supposed to be expanded with a greater pressure ratio during expansion in the working cylinder than a pressure ratio that is present during compression in the compression cylinder. Furthermore, the two axial piston motors of these two documents have in common that the compressed combustion medium coming from the compressor cylinder is first collected in a type of manifold, and then the compressed combustion medium is supplied from there to the continuously working combustion chamber, by way of a combustion medium feed line that runs through one or more heat exchangers.

It is the task of the present invention to improve the degree of effectiveness of axial piston motors of the stated type or the method for operation of axial piston motors.

The task of the invention is accomplished by means of axial piston motors or methods for operation of axial piston motors, having the characteristics of the independent claims. Further advantageous embodiments, possibly also independent thereof, are found in the dependent claims and in the following description.

In the case of an axial piston motor with internal continuous combustion, having a continuously working combustion chamber, having at least two working cylinders, and having at least two compressor cylinders driven by the working cylinders, wherein firing connections between the continuously working combustion chamber and the working cylinders can be cyclically closed and opened, and wherein a combustion medium feed line for feed of compressed combustion medium is provided between the compressor cylinders and the combustion chamber, the degree of effectiveness can be improved if an outlet of a first compressor cylinder of the two compressor cylinders is connected with an inlet of a second compressor cylinder of the two compressor cylinders.

Also, the degree of effectiveness can be improved, in the case of a method for operation of an axial piston motor with internal continuous combustion, in which compressed combustion medium is combusted in a continuously working combustion chamber together with fuel to produce working medium, the working medium is cyclically supplied to working cylinders so as to obtain mechanical energy, and the mechanical energy obtained the working cylinders is also used for compression of the combustion medium, if the compression takes place in two stages.

By means of the two stages, i.e. in that an outlet of the first compressor cylinder is connected with an inlet of a second compressor cylinder, overly great compressions do not need to be carried out in one step, contrary to the solution according to the state of the art; this in itself puts great demands on valve control and the configuration of the compressor cylinders, as well as on the stroke of the compressor piston. In the two-step solution, i.e. in the case of a connection of the outlet of the first compressor cylinder and the inlet of the second compressor cylinder, the degree of effectiveness surprisingly proves to be higher, although ultimately, control of the compressor cylinders and their outlets and inlets is significantly more complex.

In the case of a method for operation of an axial piston motor with internal continuous combustion, in which compressed combustion medium is combusted in a continuously working combustion chamber together with fuel, to produce working medium, the working medium is cyclically supplied to working cylinders, so as to obtain mechanical energy, and the mechanical energy obtained in the working cylinders is also used for compression of the combustion medium, the degree of effectiveness can also be improved in that compression takes place at final compression temperatures below 300° C. The low final compression temperature allows the compression procedure to approach isothermal compression, and this brings about a corresponding increase in the degree of effectiveness.

A corresponding low temperature during compression actually appears counterproductive in view of possible heat exchangers with which the compressed combustion medium is heated before entry into the continuously working combustion chamber. However, it has proven to be advantageous with regard to the degree of effectiveness to perform compression as isothermally as possible and at low temperatures, and only then to supply heat by way of heat exchangers.

In this regard, it is understood that due to the two-stage nature of the compression, as it was explained above, i.e. due to the connection of the outlet of the first compression cylinder with the inlet of the second compressor cylinder, monitoring of the temperature can take place in significantly simpler manner. This particularly holds true for the reason that because of the two-stage nature, smaller strokes and possibly also smaller compressor cylinders can be used. Also, cumulatively or alternatively, intermediate cooling can take place between the two stages, so that likewise, a correspondingly low final compression temperature can be guaranteed. An intermediate cooler can be provided between the outlet of the first compressor cylinder and the inlet of the second compressor cylinder, for example, for intermediate cooling, which cooler is characterized by corresponding cooling devices such as cooling ribs, cooling coils, water cooling or targeted air cooling. If necessary, such an intermediate cooler can also be used as an intermediate storage unit, wherein then, the intermediate storage unit must be correspondingly provided with cooling devices.

In particular in deviation from WO 2011/009454 A2, in which the point of departure is that a combustion medium is supposed to be expanded, during expansion in an expander stage or in the working cylinders, at a greater pressure ratio than during compression in the compressor stage, in other words in the compressor cylinders, i.e. that the compressor stage is supposed to have a smaller stroke volume than the expander stage, it has been shown that the degree of effectiveness of the axial piston motor and, in particular, also the compression ratio can be optimized, in particular, by means of control of the firing connections, wherein surprisingly, the degree of effectiveness in the case of an axial piston motor with internal continuous combustion, having a continuously working combustion chamber, having at least two working cylinders, and having at least two compression cylinders driven by the working cylinders wherein firing connections between the continuously working combustion chambers and the working cylinders can be cyclically closed and opened, and wherein a combustion medium feed line for supplying compressed combustion medium to the continuously working combustion chamber is provided between the compressor cylinders and the combustion chamber, can be improved in that a rotating distributor has at least two distributor openings, which cyclically open and close the firing connections. In this way, precisely metered control times can be implemented at a relatively small stroke of the working pistons in the respective working cylinder, which times in turn lead to correspondingly small strokes of the compressor pistons in the compressor cylinder and thereby correspondingly improve the degree of effectiveness during compression. In this regard, it has been shown that even if an improvement in the degree of effectiveness on the compressor side is not planned, the degree of effectiveness of the axial piston motor can be improved by such an embodiment, since the rotating distributor, which has at least two distributor openings that cyclically open and close the firing connections, can guarantee extremely fast and precisely definable closing and opening times within the scope of cyclical closing and opening. The same also holds true for axial piston motors with internal continuous combustion, having a continuously working combustion chamber, having at least two working cylinders, and having at least two compressor cylinders driven by the working cylinders, wherein firing connections between the continuously working combustion chamber and the working cylinders can be cyclically closed and opened, and wherein a combustion medium feed line is provided between the compressor cylinders and the combustion chamber, for supply of compressed combustion medium to the continuously working combustion chamber, if the axial piston motor is characterized in that a rotating distributor has at least two distributor openings, which are cyclically moved past firing channels or moved through firing channels. Accordingly, a method for operation of an axial piston motor with internal continuous combustion, in which compressed combustion medium is combusted in a continuously working combustion chamber together with fuel to produce working medium, the working medium is cyclically supplied to working cylinders so as to obtain mechanical energy, and the mechanical energy obtained in the working cylinders is also used for compression of the combustion medium, is advantageous if the combustion chamber simultaneously has at least two open firing connections to a working cylinder, in each instance. This holds true, in particular, if the latter takes place by way of a rotating distributor, since corresponding control times can be guaranteed in this way.

It is understood that the rotating distributor is preferably disposed coaxial to the combustion chamber. This allows a particularly simple configuration and targeted distribution. The latter holds true, in particular if the distributor is also disposed, cumulatively or alternatively, coaxial to a power take-off shaft or actually provided on it. If necessary, the control time can be varied within small limits, by means of a targeted relative displacement between the distributor and the power take-off shaft, so as to adapt this time to different speeds of rotation or different other operating conditions.

A particularly compact embodiment, which is furthermore advantageous in terms of energy and also construction, can be implemented if the rotating distributor is a combustion chamber bottom. This guarantees particularly targeted and direct distribution of the working medium at a minimum of the components involved.

Preferably, working pistons run in the working cylinders, which pistons act on a cam disk of a power take-off, which forces two strokes to occur per revolution. In particular in interplay with the two distributor openings, which are preferably coordinated, in terms of their cycle, with the working pistons that run synchronously, in each instance, a higher degree of effectiveness of the axial piston motor can be guaranteed accordingly.

Preferably, the drive of the compressor pistons that runs in the respective compressor cylinders takes place by the working cylinders, by means of a common connecting rod, in each instance. Accordingly, it is advantageous if the mechanical energy that is obtained in the working cylinders and used compression of the combustion medium is used for compression without any further conversion of energy. This also allows a particularly high degree of effectiveness, in particular in connection with compression.

If necessary, even more than two stages can be provided in connection with compression, wherein this does not appear necessary at the present point in time, since a corresponding increase in the degree of effectiveness can already be achieved with two stages, i.e. that the outlet of the first compressor cylinder is connected with the inlet of the second compressor cylinder.

Accordingly, it is advantageous if an inlet of the first compressor cylinder is connected with a combustion medium inlet, for example with an intake opening. Cumulatively or alternatively, an outlet of the second compressor cylinder can be connected with the combustion medium feed line, accordingly, so that the combustion medium compressed in the second compressor cylinder is supplied to the continuously working combustion chamber, and this can be done, in particular, by means of one or more heat exchangers.

The degree of effectiveness in the case of compression can be selected to relatively high, in particular, if the first compressor cylinder has a clearly greater diameter than the second compressor. Thus, accordingly, the first compressor cylinder can compress a significantly greater volume of air and then make it available to the second compressor cylinder, in compressed manner, so that the latter can then further compress at least approximately the same amount of air. It is understood that here, slight deviations can be provided, which are ultimately tolerated by the overall system.

Preferably, the second compressor cylinder has a cylinder surface area that corresponds to the root of the compression ratio multiplied by a surface area of the first compressor cylinder. This brings about the result that—depending on the operating point of the axial piston motor—combustion agents are optimally made available and thus the axial piston motor can be operated at a high degree of effectiveness. The same holds true analogously if multiple first and second compressor cylinders are present, the cylinder surface areas of which are compared with one another.

In this connection, it should be pointed out that the compression ratio the ratio between the compression in the first stage or in the first compressor cylinder and the compression in the second stage or in the second compressor cylinder. The compression is determined by the stroke by which the respective piston moves and the diameter of the respective cylinder. However, the available input pressure and the respective output pressure also play a significant role, wherein these, however, are dependent on the operating state of the respective axial piston motor, while stroke and diameter represent geometrically fixed variables of the respective axial piston motor. Likewise, the diameters of the feed lines and discharge lines as well as the valve opening times determine the compression. In the present connection, the statement regarding the compression ratio relates to the desired compression ratios of the two stages, taking into consideration all of these factors.

In particular, it has been found that—in contrast to discontinuous compression—a compression/expansion ratio in the case of axial piston motors with internal continuous combustion is essentially influenced by the control times of the valves, while only a subordinate role can be conceded to the diameters of the cylinders or the stroke volumes, in this regard.

Furthermore, it is advantageous if the first compressor cylinder has approximately the diameter of the working cylinder. It is true that WO 2011/009454 A2 already discloses that the combustion medium is supposed to be expanded, during expansion in the working cylinders, at a greater pressure ratio than a pressure ratio that is present during compression in the compressor cylinders, i.e. the compressor stage is supposed to have a smaller stroke volume than the stroke volume of the expander stage. However, no precise information with regard to the diameters is available. However, it has been shown that even clearly smaller diameters than the diameter of the working cylinder can deliver very good results. Thus, the diameter of the first compressor cylinder can be less than 90% of the diameter of one of the working cylinders. In particular, this can be less than 85%, preferably even less than 83%. Here, a diameter of the first compressor cylinder seems to be the lower limit if no gain in degree of effectiveness is present any longer in the case of further reduction, since then, increased friction and the like occurs. Accordingly, in the case of multiple first compressor cylinders, diameter sums of the first compressor cylinders can be compared with diameter sums of the corresponding number of working cylinders.

In particular, the first compressor cylinder or the first compressor cylinders can be dimensioned in such a manner that sufficiently compressed combustion medium for idling of the axial piston motor is made available by the first compressor cylinder(s). Also, cumulatively or alternatively, sufficiently compressed combustion medium for idling of the axial piston motor can be made available in the first stage. In a concrete implementation, for example, one or more combustion agent lines can be provided directly from the first compressor cylinder(s) or the first stage to the combustion chamber. Also, the compressed combustion agent can simply be conveyed through the second stage or through the second compressor cylinder(s), without noteworthy compression taking place in the second stage or in the second compressor cylinder(s). In the case of such dimensioning of the first compressor cylinder(s) or in the case of such a configuration of the first stage, further compression in the second stage or in one or more second compressor cylinder(s) can be eliminated during idling, and this is correspondingly advantageous in terms of energy. The latter actually takes place automatically if only a low pressure is demanded of the combustion chamber during idling and a high pressure is demanded at full load.

It is understood that multiple first compressor cylinders, in particular, each having an outlet, or multiple second compressor cylinders, each having an inlet, can be provided, which cylinders are particularly disposed in accordance with the cycles of the axial piston motor or of the operating method.

In this regard, in a concrete embodiment, each of the outlets of the respective first compressor cylinder can be connected with precisely one of the inlets of one of the second compressor cylinders, so that the compressor stages take place exactly and precisely between these compressor cylinders, in each instance.

On the other hand, it is conceivable that one outlet of one of the multiple first compressor cylinders is connected with multiple inlets of the second compressor cylinders. Likewise, one inlet of the second compressor cylinders can be connected with multiple outlets of the first compressor cylinders, so that the combustion medium compressed by the first compressor cylinders, in each instance, is then available to at least two second compressor cylinders, as needed. This results in a certain buffer, which can be used for intermediate cooling, for one thing and, for another thing, can even out possible imprecisions in the control of the inlets and outlets, i.e. in the compression in the individual compressor cylinders.

It is understood that accordingly, each of the first compressor cylinders should also have an inlet, and each of the second compressor cylinders should also have an outlet, in each instance, wherein—depending on the concrete implementation—the inlets of the first compressor cylinders can be connected with their own combustion medium inlet or, alternatively, with common combustion medium inlets, or even only with a common combustion medium inlet, or, in a deviating embodiment, with a prior compressor stage. Likewise, the outlets of the second compressor cylinders can be connected with their own combustion medium feed lines to the combustion chamber, in each instance, which lines run through heat exchangers, in each instance, jointly or separately, or run through specially designed heat exchangers, in each instance. Likewise, it is conceivable that the outlets of the second compressor cylinders are first collected and are then connected with the combustion chamber with only one combustion medium feed line or, proceeding from a collector, by way of multiple combustion medium feed lines, which can also run through heat exchangers, if necessary. Also, the second compressor cylinders can be followed by a third compressor stage, if necessary, in that the outlets are connected with one or more inlets of third compressor cylinders, in each instance.

As has already been explained above, intermediate cooling can be provided between the compressor stages. Accordingly, the compression can approach isothermal compression if intermediate cooling takes place between the two stages or if an intermediate cooler is provided between the outlet of the first compressor cylinder and the inlet of the second compressor cylinder.

Such an intermediate cooler has technical measures that go beyond simple line guidance or simple walls in order to ensure cooling. In particular, such an intermediate cooler can comprise cooling ribs, cooling plates or even cooling walls. Also, separate inflow of coolant, for example cooling air or cooling fluid, can take place. Likewise, it is conceivable to conduct cooling coils past corresponding walls, in which the combustion medium is supposed to be cooled, in order to make a corresponding intermediate cooler available.

Preferably, it is ensured that the compression takes place at final compression temperatures below 280° C., in particular below 270° C. In this way, isothermal compression can be approached.

An intermediate storage unit can be provided between the outlet of the first compressor cylinder and the inlet of the second compressor cylinder, so that a certain excess of combustion medium compressed in the first compressor cylinder can be temporarily stored in the intermediate storage unit, which excess can then be used for short-term power increases or for startup processes. It is true that such an intermediate storage unit can have a separate inlet and a separate outlet, so that—since the combustion medium is gaseous—it passes the combustion medium through, in a certain manner, but this is relatively complicated in terms of construction. Preferably, the intermediate storage unit merely comprises a connector with the outlet of the first compressor cylinder and with the inlet of the second compressor cylinder, so that the combustion medium can get into the intermediate storage unit and out of the intermediate storage unit by means of this single connector. In order to guarantee precise control of the intermediate storage unit, the respective connectors are preferably provided with corresponding valves. If necessary, the intermediate storage unit can also be used as an intermediate cooler, if corresponding cooling measures are provided, as has already been explained above.

It is understood that the characteristics of the solutions described above and in the claims can also be combined, if applicable, in order to be able to implement the advantages cumulatively, accordingly.

Further advantages, goals, and properties of the present invention will be explained using the following description of exemplary embodiments, which are particularly also shown in the attached drawing. The drawing shows:

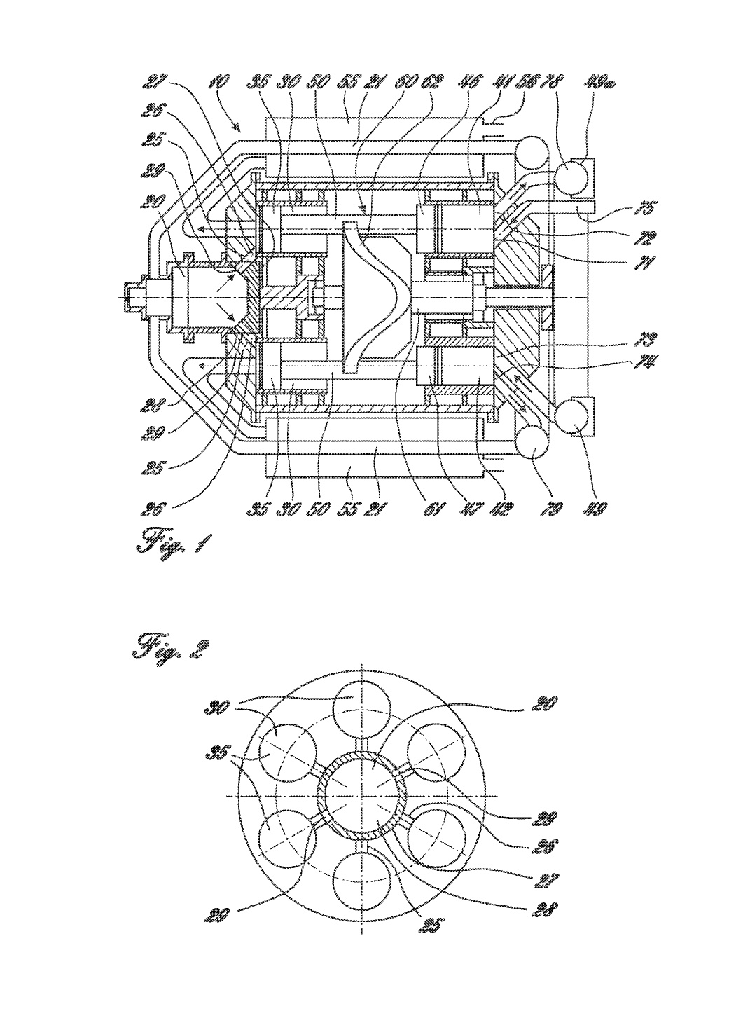

FIG. 1 a schematic sectional view of a first axial piston motor;

FIG. 2 a schematic cross-section through the combustion chamber bottom of the axial piston motor according to FIG. 2;

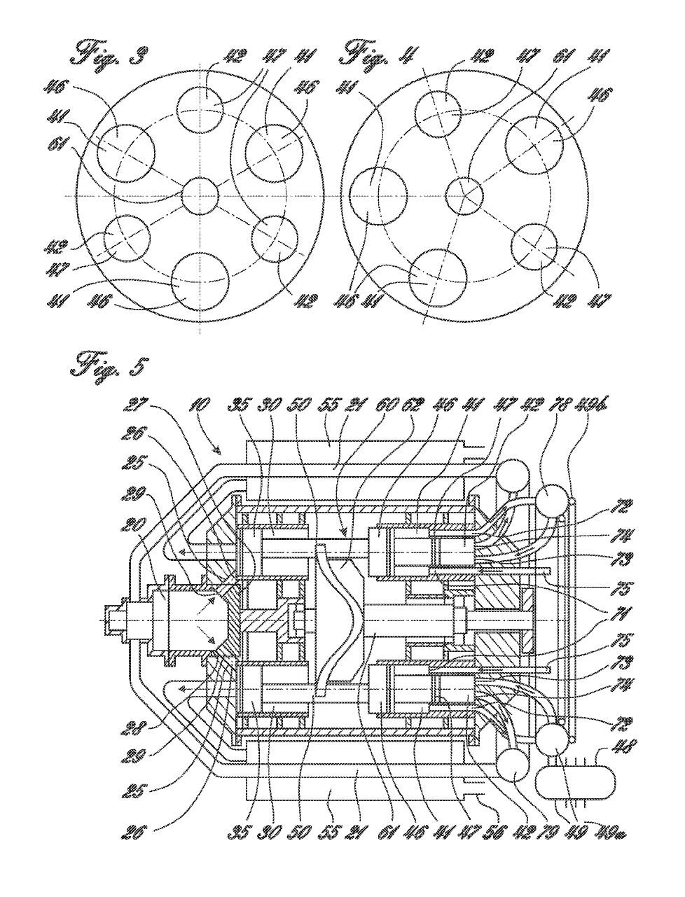

FIG. 3 a schematic cross-section through the compressor cylinders of the axial piston motor according to FIGS. 1 and 2;

FIG. 4 a schematic cross-section through the compressor cylinders of a second axial piston motor;

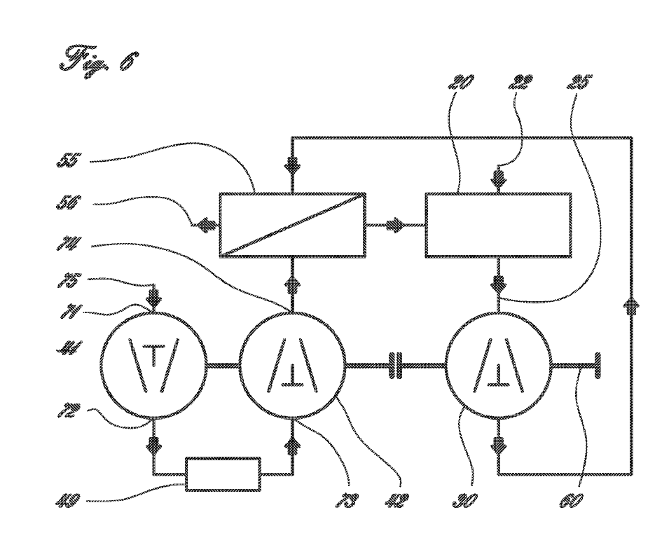

FIG. 5 a schematic sectional view of a third axial piston motor in a representation similar to FIG. 1; and

FIG. 6 a diagram of the principle of the axial piston motors according to FIGS. 1 to 5.

The axial piston motors 10 shown in the drawing each have a combustion chamber 20, to which combustion medium is supplied by way of combustion medium feed lines 21, which medium is continuously combusted together with fuel, which is applied to the combustion chamber 20 by way of one or more fuel feed lines 22 of the combustion chamber 20, to produce working medium.

The working medium is passed to working cylinders 30 by way of firing connections 25, which are configured as firing channels 26 in these exemplary embodiments, in which cylinders working pistons 35 run back and forth, which pistons obtain mechanical energy from the working medium and pass this energy, in turn, to a power take-off 60, which in turn comprises a cam disk 62 and a power take-off shaft 61.

In this regard, the working pistons 35 are provided with connecting rods 50, which run back and forth on the cam disk 62.

Furthermore, the mechanical energy obtained by means of the working pistons 35 or in the working cylinders 30 is passed to compressor pistons 46, 47, which run back and forth in compressor cylinders 41, 42, so that compression of the combustion medium is carried out there.

The compressed combustion medium then gets back to the combustion chamber 20 by way of the combustion medium feed line 21, wherein it also runs through heat exchangers 55 for this purpose, in which the thermal residual energy of the working medium can then be passed to the combustion medium supplied to the continuously working combustion chamber 20. The working medium leaves the heat exchangers 55 as exhaust gas 56.

It is understood that in deviating embodiments, only one heat exchanger 55 and only one combustion medium feed line 21 can be provided. Likewise—under some circumstances—a combustion medium feed line 21 that does not run through a heat exchanger can be provided in special embodiments. Also, there are embodiments in which multiple heat exchangers 55 are provided, through which multiple combustion agent feed lines 21 or combustion agent feed lines 21 from multiple compressor cylinders 41, 42 and/or multiple working medium lines or working medium lines from multiple working cylinders pass.

The combustion chamber 20 can be configured in one stage, two stages or multiple stages, but ultimately, this is unimportant for an explanation of the present invention. As is evident from FIG. 6, as much energy as possible can be recovered from the working medium after it leaves the working cylinders 30, the lower the temperature of the compressed combustion agent upon entry into the heat exchanger.

In all the exemplary embodiments, the axial piston motor 10 has a rotating distributor 27, in each instance, which distributes working medium to the working cylinders 30 successively, in each instance.

In this regard, the rotating distributor 27 is configured as a combustion chamber bottom 28 in these exemplary embodiments, wherein purely theoretically, other embodiments, such as a separate rotating distributor ring that rotates in the firing channels 26 and separates them, for example, or also a different rotating device that is able to distribute working medium successively to the working cylinders 30 can be provided.

The rotating distributor 27 has distributor openings 29 that run past the firing channels 26 during rotation, in each instance, so that in this manner, the firing connections 25 can be speedily opened and closed.

In the present exemplary embodiment, the rotating distributor 27 is connected with the drive shaft 61 or the cam disk 62, so that it rotates along with the latter. If necessary, the synchronization between the rotation of the distributor 27 and the rotation of the cam disk 62 or of the power take-off shaft 61 can be adapted to the given operating conditions, such as short-term power demand or different speeds of rotation, by means of a displacement of the angle of rotation of the rotating distributor 27 with regard to the cam disk 62 or with regard to the power take-off shaft 61.

In the case of the present exemplary embodiments, compression takes place in two stages, in each instance, so that structurally separable first compressor cylinders 41 and second compressor cylinders 42 are defined. It is understood that if necessary, it is possible to eliminate two-stage compression and therefore a differentiation between first compressor cylinders 41 and second compressor cylinders 42 if the advantages of the rotating distributor and the related characteristics are to be utilized individually. Likewise, it is possible to eliminate the rotating distributor 27 if the firing connections 25 are utilized in conventional manner and two-stage compression is to be provided.

Each of the compressor cylinders 41, 42 has an inlet 71, 73 and an outlet 72, 74, in each instance.

In this regard, the inlets 71 of the first compressor cylinders 41 are connected with a combustion medium inlet 75, in each instance, wherein in deviating embodiments, multiple inlets 71 of the first compressor cylinders 41 can also be connected with a common combustion medium inlet 75.

Also, the outlets 72 of the first compressor cylinders 41 are connected with the inlets of the second compressor cylinders 42, in each instance; this is done, in the present exemplary embodiments, by way of a manifold 78, in each instance, which is also utilized as an intermediate cooler 49. It is understood that in place of the manifold 78, a direct connection between an outlet 72 of the first compressor cylinder 41 and an inlet 73 of the second compressor cylinder 42 can be provided, in each instance, so that a first compressor cylinder 51 communicates with precisely one second compressor cylinder 42, in each instance.

In order for the manifold to be able to be active as an intermediate cooler 49, it is provided, in the exemplary embodiment according to FIGS. 1 to 4, with cooling plates 49a, while it has cooling coils 49b in the exemplary embodiment according to FIG. 5, in which cooling medium flows.

In this manner, the final compression temperature can be restricted to 250° C. at a compression ratio of 16 over both stages, due to the two-stage nature and the intermediate cooling. This makes it possible for the compression to approach isothermal compression with its correspondingly good degree of effectiveness.

In the exemplary embodiment according to FIG. 5, an intermediate storage unit 48 is furthermore provided, which is connected with the manifold 78 by way of a line, not numbered in any detail, in which a valve, not shown in any detail, is provided, so that here, compressed combustion medium can be temporarily stored in the first stage. In this exemplary embodiment, the intermediate storage unit 48 also serves as an intermediate cooler 49, and is also provided with cooling plates 49a for this purpose. Since the combustion medium is frequently supposed to be temporarily stored in the intermediate storage unit 48 over an extended period of time, it is easily possible to eliminate an embodiment of the intermediate storage unit 48 as an intermediate cooler 49 if, for example, short-term intermediate storage remains the exception in a corresponding operating method.

Furthermore, the outlets 74 of the second compressor cylinder 42 are provided with a manifold 79, in each instance, from which the combustion medium feed lines 21 proceed.

As is directly evident, the combustion medium therefore reaches the heat exchangers 55 at a temperature that is as low as possible; this actually appears counterproductive in terms of thermodynamics, since the important thing ultimately appears to be bringing the combustion medium to the combustion chamber 20 at a temperature that is as high as possible. On the other hand, isothermal compression proves to be so effective, in terms of energy, that the effort for intermediate cooling or two-stage compression appears to be justified.

In the present exemplary embodiments, the first compressor cylinders 41 have a clearly greater diameter than the second compressor cylinders 42. The diameter of the first compressor cylinders 41 is 1.8 times the diameter of the second compressor cylinders 42.

Furthermore, in these exemplary embodiments the diameters of the first compressor cylinders 41 are approximately as great as the diameters of the working cylinders 30. In concrete terms, the diameter of the first compressor cylinders 41 is smaller than the diameter of the working cylinders 30, but not less than 96% of the diameter of the working cylinders 30.

In the exemplary embodiment according to FIGS. 1 to 4, precisely one compressor cylinder 41, 42 or compressor piston 46, 47 is provided for each working piston 35 or working cylinder 30, wherein in the exemplary embodiment according to FIGS. 1 to 3, three first compressor cylinders 41 and three second compressor cylinders 42 are provided, in each instance, which are disposed with rotation symmetry with regard to the power take-off shaft 61 or the cam disk 62 and the combustion chamber 20, so that the axial piston motor 10 runs as balanced as possible, wherein possible imbalances can be further minimized by means of configurations of the connecting rods and of the pistons.

Fundamentally, the arrangement in the case of the axial piston motor 10 according to FIG. 4 is similar, so that precisely one working cylinder 30 is also provided for each compressor cylinder 41, 42, which cylinders are arranged coaxially, in each instance. However, only two second compressor cylinders 42 and three first compressor cylinders 41 are provided, which are accordingly arranged around the power take-off shaft 41, the cam disk 62 or the combustion chamber 20 as symmetrically as possible. Here, too, the cam disk 62 can be configured in such a manner that it forces two strokes to occur per revolution, wherein then the distributor openings 29 should be structured in suitable manner and have the firing channels 26 on different levels, if applicable, and interact with different distributor openings 29. Likewise, of course, here a conventional opening of the firing connections 25 can be provided. Also, it is conceivable to provide merely one distributor opening 29, and to configure the cam disk 62 in such a manner that it only forces one stroke to occur per revolution.

In the exemplary embodiment shown in FIG. 5, two compressor cylinders 41 interact with one working piston 35. For this purpose, the related compressor pistons 46, 47 sit on top of one another, wherein it is advantageous to set the compressor piston 47 of the second compressor cylinder 42, which preferably should have a smaller diameter, onto the compressor piston 46 of the first compressor cylinder 41.

### REFERENCE SYMBOL LIST

10 axial piston motor
20 combustion chamber
21 combustion medium feed line
22 fuel feed line
25 firing connections
26 firing channel
27 rotating distributor
28 combustion chamber bottom
29 distributor opening
30 working cylinder
35 working piston
41 first compressor cylinder
42 second compressor cylinder
46 compressor piston
47 compressor piston
48 intermediate storage unit
49 intermediate cooler
49a cooling plate
49b cooling coil
50 connecting rod
55 heat exchanger
56 exhaust gas
60 power take-off
61 power take-off shaft
62 cam disk
71 inlet of the first compressor cylinder 41
72 outlet of the first compressor cylinder 41
73 inlet of the second compressor cylinder 42
74 outlet of the second compressor cylinder 42
75 combustion medium inlet
78 manifold
79 manifold

1. An axial piston motor (10) with internal continuous combustion, having a continuously operating combustion chamber (20), having at least two working cylinders (30), and having at least two compressor cylinders (41, 42) driven by the working cylinders (30), wherein firing connections (25) between the continuously working combustion chamber (20) and the working cylinders (30) can be cyclically closed and opened, and wherein a combustion medium feed line (21) for supplying compressed combustion medium to the continuously working combustion chamber (20) is provided between the compressor cylinders (41, 42) and the combustion chamber (20), wherein an outlet (72) of a first compressor cylinder (41) of the two compressor cylinders (41, 42) is connected with an inlet (73) of a second compressor cylinder (42) of the two compressor cylinders (41, 42).

2. The axial piston motor (10) according to claim 1, wherein an inlet (71) of the first compressor cylinder (41) is connected with a combustion medium inlet (75), and an outlet (74) of the second compressor cylinder (42) is connected with the combustion medium feed line (21).

3. The axial piston motor (10) according to claim 1, wherein the second compressor cylinder (42) has a cylinder surface area or the second compressor cylinders (42) in total have a cylinder surface area that corresponds to the root of the compression ratio multiplied by a surface area of the first compressor cylinder (41) or of the first compressor cylinders (41).

4. The axial piston motor (10) according to claim 1, wherein the diameter of the first compressor cylinder (41) is less than 90%, preferably less than 85%, in particular less than 83% of the diameter of one of the working cylinders (30).

5. The axial piston motor (10) according to claim 1, wherein the first compressor cylinder (41) is dimensioned or the first compressor cylinders (41) are dimensioned in such a manner that sufficiently compressed combustion medium for idling of the axial piston motor (10) is made available by the first compressor cylinder(s) (41).

6. The axial piston motor (10) according to claim 1, wherein the rotating distributor (27) is a combustion chamber bottom (28).

7. The axial piston motor (10) according to claim 1, wherein a rotating distributor (27) has at least two distributor openings (29), which cyclically open and close the firing connections (25) and/or are cyclically moved past firing channels (26) or passed through firing channels (26).

8. The axial piston motor (10) according to claim 1, wherein working pistons (35) run in the working cylinders (30), which pistons act on a cam disk (62) of a power take-off (60), which disk forces two strokes to occur per revolution.

9. The axial piston motor (10) according to claim 1, wherein multiple first compressor cylinders (41), each having an outlet (72), and/or multiple second compressor cylinders (42), each having an inlet (73), are provided, wherein each of the outlets (72) is connected with precisely one of the inlets (73) or wherein an outlet (72) is connected with multiple inlets (73) and/or one inlet (73) is connected with multiple outlets (72).

10. The axial piston motor (10) according to claim 1, wherein an intermediate storage unit (48) and/or an intermediate cooler (49) is provided between the outlet (72) of the first compressor cylinder (41) and the inlet (73) of the second compressor cylinder (42).

11. A method for operation of an axial piston motor (10) with internal continuous combustion, in which compressed combustion medium is combusted in a continuously working combustion chamber (20) together with fuel to produce working medium, the working medium is cyclically supplied to working cylinders (30) so as to obtain mechanical energy, and the mechanical energy obtained in the working cylinders (30) is also used for a compression of the combustion medium, wherein compression takes place in two stages and/or wherein compression takes place at final compression temperatures below 300° C.

12. The operating method according to claim 11, wherein the combustion chamber (20) simultaneously has at least two open firing connections (25) to a working cylinder (30), in each instance.

13. The operating method according to claim 11, wherein intermediate cooling takes place between the two stages.

14. The operating method according to claim 11, wherein compression takes place at final compression temperatures below 280° C., preferably below 270°C.

15. The operating method according to claim 11, wherein sufficiently compressed combustion medium for idling of the axial piston motor (10) is made available in the first stage.
